(19) United States
(12) Patent Application Publication
(10) Pub. No.: US 2016/0084986 A1
(43) Pub. Date: Mar. 24, 2016

(54) Snow and Ice Melting System and Sensors Therefor

(71) Applicant: Pentair Thermal Management LLC, Menlo Park, CA (US)

(72) Inventors: Juergen J. Zach, Menlo Park, CA (US); Arsham Shahriar Shirkhani, Menlo Park, CA (US)

(21) Appl. No.: 14/860,569

(22) Filed: Sep. 21, 2015

Related U.S. Application Data
(60) Provisional application No. 62/052,632, filed on Sep. 19, 2014.

(51) Int. Cl. G01V 8/10; E04D 13/076; H05B 1/02; E04H 9/16; E01C 11/26; G01V 3/02; E04D 13/10; E04B 1/92

(52) U.S. Cl. CPC G01V 8/10; E04D 13/103; E04D 13/106; E04D 13/0762; E04B 1/92; E04H 9/16; E01C 11/265; G01V 3/02; H05B 1/0227

(57) ABSTRACT

Embodiments of the invention provide a snow and ice melting heating system that can include a capacitive probe, such as an aerial probe, having a capacitive sensor to improve detection of the onset or accumulation of snow or ice. The capacitive probe provides uniform response to the presence of snow and ice on the capacitive sensor, and the capacitive sensor can be protected from galvanic corrosion by one or more coatings without affecting the detection of snow or ice. The capacitive probe can indicate when heaters should be turned on to melt snow or ice. The system can include a light probe having a color sensor to detect snow cover, or lack thereof, on a monitored surface from the color of reflected light. The light probe provides a monitoring device that can detect when the snow cover has melted and signal for the system heaters to be turned off.

### CROSS-REFERENCE TO RELATED APPLICATIONS

This application is a non-provisional claiming the benefit of U.S. Prov. Pat. App. Ser. No. 62/052,632, entitled “SNOW AND ICE MELTING SYSTEM AND SENSORS THEREFOR,” filed Sep. 19, 2014, and incorporated fully herein by reference.

### BACKGROUND

In sub-freezing climates, snow and ice accumulation on surfaces can cause injury to persons and property, affecting all types of structures that are exposed to the environment. In particular, roadways, driveways, sidewalks, and roofs and gutters of buildings are at risk of damage and can harbor dangerous conditions when covered in snow or ice. Snow-melting and de-icing systems exist for applying heat to the snow and ice or to the covered surfaces, referred to herein as “heated surfaces.” The thermal energy melts the snow and ice and eliminates the associated hazards.

Several devices for generating the necessary thermal energy exist. While the systems of the present disclosure may utilize some or all known heat-generating devices, they are particularly applicable to control of heat tracing cables. Heat tracing cables have one or more electrical conductors or conductor arrangements that generate heat along the cable length when an electrical current is applied to the conductor(s). The cables are connected to one or more controllers that manage power application to the cables. Typically, controllers include or communicate with environmental sensors that detect when snow or ice is present and, therefore, when heat is needed.

Present heat tracing systems for frost and snow protection and roof and gutter de-icing rely on a precipitation sensor that senses a drop in resistivity between a set of electrodes as the snow falls on a heated surface. These systems are maintenance-intensive because the galvanic exposure of the sensing electrodes degrades the electrodes, and because the electrodes become dirty and less effective at detecting precipitation. A sensor that will not be hindered by galvanic corrosion and dirt, and can be used in heat tracing systems for melt applications, is needed.

Another disadvantage of traditional snow sensing systems using precipitation sensors is that the systems can measure the onset of snow conditions effectively, but cannot detect when heat is no longer needed. This is because the sensors operate based on the presence of moisture in contact or near the sensor itself. Even if snow or ice is melted from the immediate area around the sensor, it might still be present in other areas. Furthermore, with some types of presently used sensors, moisture will still be present in the form of water for a period of time, and the sensors will not “turn off”, thereby wasting energy. As a result, present systems are configured to operate the heaters for fixed durations based on conservative estimates of the energy needed for the “worst-case-scenario” snow conditions. The alternative would be risking unsafe conditions in case of insufficient heat, but the drawback is that more energy than necessary is almost always used. A system that can detect when the snow or ice has been sufficiently melted is needed.

Finally, sensors in existing systems are small point sensors, requiring contact of snow or ice with an active surface area of the sensor which, including the electrodes, is very small compared to the monitored surface. In some situations, snow or ice may accumulate on the monitored surface but not in contact with the point sensor. Thus, a hazardous condition could exist without the sensor detecting it. A type of sensor that can detect the presence of snow or ice over a wider area is needed.

Some sensor designs that offer improvements over the precipitation sensors described above have been used in other areas of technology to detect snow or ice. Capacitive sensors, in which the snow or ice makes up the dielectric filler of a fringe or air capacitor to change the capacitance thereof, have been used in applications such as ice making, depth sounding, and detecting rain on automobile and home windows. Some of these designs avoid exposure of the electrical conductors in the capacitor to the environment, and thus lessen or eliminate galvanic corrosion. However, capacitive sensors remain small point sensors and are affected by the presence of melted snow and ice, and thus are susceptible to some of the drawbacks of present precipitation sensors. Optical sensors can record a color and, via data processing, a color change of a monitored area. Optical sensors can be protected from the elements and configured to monitor large areas, and are not dependent on contact with the snow and ice to detect it. The present disclosure provides snow and ice melting systems for surfaces using improved sensors, such as capacitor and optical sensors designed for use in the system, and controllers to activate and deactivate heaters in the system.

### SUMMARY

Some embodiments of the invention provide an apparatus for detecting the presence of snow or ice on a monitored surface. The apparatus includes a capacitive sensor having a substrate, a fringe capacitor made of a pair of electrodes positioned on the substrate, uniformly spaced apart, and arranged in a spiral, one or more coatings covering the fringe capacitor such that the fringe capacitor is protected from galvanic corrosion and responds to snow or ice present between the electrodes, and probing electronics electrically connected to the capacitive sensor and configured to read the sensor. The spiral can be circular. The probing electronics can apply power to the capacitive sensor to charge and discharge the fringe capacitor at an excitation frequency greater than 10 kHz.

The apparatus can further include a housing containing the capacitive sensor and the probing electronics, the capacitive sensor being positioned in the housing such that the fringe capacitor receives snow or ice that accumulates on the monitored surface. The apparatus can further include a structural support attached to the housing, the structural support being configured to space the housing away from the monitored surface. The apparatus can further include one or more heating elements disposed in the housing and positioned to heat the capacitive sensor. The apparatus can further include a satellite controller attached to the housing and protected from environmental conditions by the housing, the satellite controller being electrically connected to the probing electronics or located in the same housing as the probe electronics, and configured to receive data read from the sensor. The satellite controller can be in communication with a main controller of a snow and ice melting system, and can transmit a signal to the main controller to activate one or more heaters of the snow and ice melting system when the satellite controller receives data from the sensor indicating the presence of snow or ice.

Some embodiments of the invention provide an apparatus for detecting the presence or absence of snow on a monitored surface. The apparatus includes a housing having an aperture, a lens disposed in the aperture and positioned to receive light reflected from a monitored area of the monitored surface, a color sensor disposed in the housing and positioned so that an active area of the color sensor is near the lens focal point, and a microcontroller electrically connected to the color sensor and configured to receive surface data from the color sensor, the surface data indicating the color of the light received by the lens. The color sensor can be an RGB sensor. The apparatus can further include one or more light sources arranged to illuminate the monitored area. The apparatus can further include a reference overlay placed over the monitored surface in the monitored area, the reference overlay having a uniform color detectably different from snow.

Some embodiments of the invention provide a snow and ice melting system that includes one or more heating devices positioned to heat a monitored surface to a temperature sufficient to melt accumulated snow and ice, a main controller electrically connected to the heating devices and to a power source and configured to start and stop power to the heating devices, one or more capacitive probes in electrical communication with the main controller, and one or more light probes in electrical communication with the main controller. The capacitive probe has a capacitive sensor including a fringe capacitor made of a pair of electrodes positioned on a substrate, the pair of electrodes being uniformly spaced apart and arranged in a spiral. The capacitive probe has one or more coatings covering the fringe capacitor such that the fringe capacitor is protected from galvanic corrosion and responds to snow or ice present between the electrodes. The light probes have a color sensor and are configured to detect the color of light reflected from the monitored surface.

Some embodiments of the invention provide a capacitive probe that includes a housing mountable to a building approximate an area to be monitored by the capacitive probe, a capacitive sensor disposed partially within the housing, and a sensor heater disposed in the housing and configured to heat the monitored surface a sufficient amount to melt snow on the monitored surface. The capacitive sensor includes a substrate, a fringe capacitor having a pair of electrodes positioned on the substrate and at least partially arranged in a circular spiral that generates a fringe field having a range, and a cap attached to the substrate and disposed over the fringe capacitor. The cap is composed of a polytetrafluoroethylene (PTFE) material having a uniform dielectric constant throughout the cap. The cap has a receiving surface disposed outside of the housing and at least partially disposed within the range of the fringe field. The capacitive sensor can be disposed at a top of the housing and the sensor heater can be disposed at a bottom of the housing, and the capacitive probe can further include a fan disposed to uniformly distribute the heat generated by the sensor heater throughout the housing.

The capacitive probe can further include a satellite controller disposed in the housing and having a microcontroller communicatively coupled to the sensor heater, and probing electronics communicatively coupled to the microcontroller and to the capacitive sensor. The microcontroller can store, in memory, program instructions and a detection threshold value based on a baseline capacitance of the fringe capacitor, the baseline capacitance measured when no moisture is present within the range of the fringe field and while the fringe capacitor is charged and discharged at an excitation frequency. The microcontroller can execute the program instructions to activate a capacitance reading operation in which the probing electronics charge and discharge the fringe capacitor at the excitation frequency, determine a detected capacitance value obtained by the probing electronics during the capacitance reading operation, determine that the detected capacitance value is greater than the detection threshold value, and send a signal to a main controller in signal communication with the satellite controller, the signal instructing the main controller to activate a heater installed on the structure. The excitation frequency can be 10 kHz or less, or can be over 10 kHz, specifically 20 kHz or higher, and more specifically 40 kHz or higher. The detection threshold value can be 100 pF or less, specifically 50 pF or less, more specifically 30 pF or less, and even more specifically 10 pF or less.

### DESCRIPTION OF THE DRAWINGS

FIG. 1 is a perspective view of a typical heat trace snow melting system for the roof of a building.

FIG. 2 is a schematic diagram of the heat trace snow melting system of FIG. 1.

FIG. 3 is a top view of an embodiment of a capacitive snow sensor.

FIG. 4A is a top view of another embodiment of a capacitive snow sensor.

FIG. 4B is a partial close-up top view of the capacitive snow sensor of FIG. 4A.

FIGS. 5A and 5B are graphs showing a fringe field of a capacitive sensor in accordance with the present disclosure.

FIG. 6 is a top perspective view of an embodiment of a capacitive sensor in accordance with the present disclosure, shown with a partial cutaway of a cover.

FIG. 7 is a schematic diagram of an embodiment of a heat trace snow melting system in accordance with the present disclosure.

FIG. 8A is a side view of an embodiment of an exterior temperature sensor in accordance with the present disclosure.

FIG. 8B is a sectional front view of the exterior temperature sensor of FIG. 8A taken along line 8-8 of FIG. 8A.

FIG. 9 is a diagram of an exemplary sensing and heating control circuit in accordance with the present disclosure.

FIG. 10 is a flowchart showing a self-testing process of a satellite controller.

FIG. 11 is a front left perspective view of another embodiment of an aerial capacitive sensor in accordance with the present disclosure.

FIG. 12 is a top perspective view of the aerial capacitive sensor of FIG. 11.

FIG. 13 is a front left perspective view of the aerial capacitive sensor of FIG. 11 within a wind shield.

FIG. 14 is a graph showing a capacitance plot for a capacitive sensor in accordance with the present disclosure.

FIG. 15 is an end view of an embodiment of capacitive snow sensors for gutter applications.

FIG. 16 is a perspective view of an embodiment of an embedded capacitive snow sensor.

FIG. 17 is a schematic diagram of another embodiment of a heat trace snow melting system in accordance with the present disclosure.

FIG. 18 is a schematic diagram of a light probe of the heat trace snow melting system of FIG. 18.

FIG. 19 is a diagram of an exemplary sensor housing for a light probe.

FIG. 20 is a schematic diagram of another embodiment of a heat trace snow melting system in accordance with the present disclosure.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

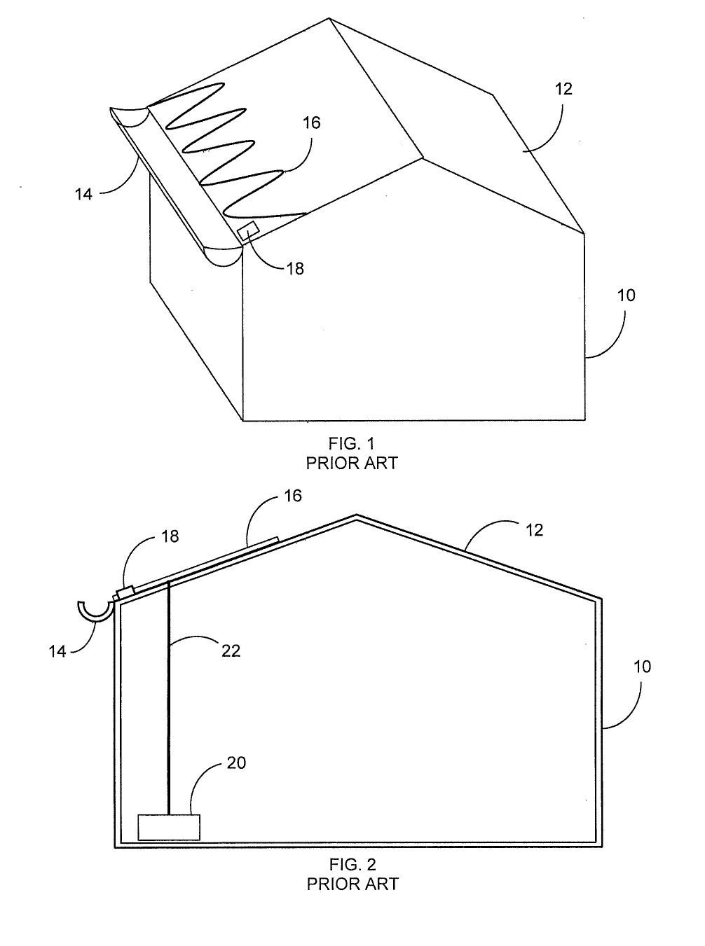

FIGS. 1 and 2 illustrate an example layout of an existing snow and ice melting system that may be improved by the systems described herein. The illustrated system heats the roof 12 and gutters 14 of a building 10, such as a residential home or office building. Heat, or thermal energy, is provided by one or more trace heating cables 16 attached to (or, in alternative embodiments, embedded in) the surfaces of the roof 12 and gutters 14 to create a heated surface thereon. The heating cables 16 will melt snow and ice directly by contact with the snow and ice, or indirectly by heating the heated surfaces. One or more sensors 18, which are typically precipitation sensors as described above, are disposed on the roof 12 and/or in the gutters 14 to detect the presence of snow or ice.

The heating cables 16 are electrically connected in parallel or in series to a controller 20 that supplies power to the heating cables 16, such as via a power cable 22. The controller 20 can be CPU- or microprocessor-powered and can be connected to the building mains power or a separate generator. The controller 20 communicates with the sensors 18 to receive their data. The controller 20 and sensors 18 can be equipped with any suitable wired or wireless communication protocol as is known in the art. Typically, the controller 20 polls the sensors 18 for their status at regular intervals, but alternatively the sensors 18 can be configured to transmit a change of state to the controller 20. Upon receiving data from the sensors 18 that there is snow or ice present, the controller 20 applies power to the heating cables 16 for a predetermined length of time to melt the snow and ice.

Prior art systems like the one of FIGS. 1 and 2 are implemented to heat many different types of surfaces, including roadways, sidewalks, driveways, and other surfaces where snow and ice accumulate. The type of heater used may vary depending on cost, surface, and location particulars of any application. The improved sensors and system designs described herein can be implemented in any such prior art design, taking into account the commensurate modifications described herein, or other modifications that are ascertainable from the present disclosure without undue experimentation.

Capacitance Sensing

In the present systems, the known sensors 18 can be replaced or complemented by a capacitive probe configured to detect the presence of snow or ice on or in the vicinity of the roof 12 and gutters 14, and to transmit data to a primary controller (e.g., controller 20) that activates the heater cables 16 based at least in part on the transmitted data. Correspondingly, the primary controller or other controllers in the system can be modified or configured to perform certain advantageous analyses of the probe data, and other sensors and probe components can be included, to improve efficiency of the system operation; examples of such configurations are provided herein.

Capacitor Design

Capacitive probes can include a capacitive sensor having a fringe capacitor or air capacitor. The capacitor can be designed, as described below, so that the output of the capacitive sensor reflects incidence on the capacitor of water, or rather of a substance with the permittivity of water. The relative permittivity (or dielectric constant) of water molecules is more than an order of magnitude greater than any other naturally occurring material which is mobile enough to land on a sensor. Hence, the capacitance of such a fringe capacitor may be enhanced by several hundred percent in case of precipitation. No galvanic contact is necessary; as such, a capacitive sensor can sense through thin enclosures made of plastic and other materials, rendering the durability limited only by the enclosure.

There are many formulas in use for the capacitance of different shapes, but it is risky to attempt to design a capacitor with a novel geometry without a fundamental electrostatic analysis conducted either using a numerical solver or analytically using Maxwell's equations. In general, capacitors consist of two interacting conductors, which acquire a charge distribution once a potential difference is forced upon them. In principle, any electrostatic problem can be analyzed by solving the Poisson equation with the appropriate boundary conditions (applied voltages and possibly ground). Regardless of the configuration, the resulting total charge on both electrodes of a capacitor is proportional to the applied voltage, and their ratio is the capacitance.

When polarizable matter with a relative permittivity ∈ᵣ greater than one is introduced between the capacitor electrodes, the capacitor's ability to store charge, and therefore energy, increases, which can be expressed by a greater capacitance C=∈ᵣC_{vac} (this equation is strictly only valid if the entire space between the electrodes is filled up with the same material, but it suffices to explain the trend). Hence, a capacitor turns into a sensor for relative permittivity when a high amount of the space between the electrodes is filled with the substance to be probed. As the relative permittivity of water, snow, and ice (80-120) is several magnitudes higher than other substances likely to accumulate on the sensor 34, such as organic debris (wood, leaves, etc., at about 2-5 relative permittivity) and soil (2-6 relative permittivity), the capacitive sensor 34 can be designed to discern between substances thereon.

In a standard parallel plate capacitor, the lines of the electric field are concentrated in the space between the plates, apart from fringe effects. Thus, any sensed substance would need to be placed between the plates to generate an enhanced capacitance in the capacitor. For an ambient snow or ice sensor, such a capacitor cannot achieve the design goals because a smooth and flat surface that does not expose the electrodes or trap debris, and provides for easy runoff of the melt, is desired. Instead, a design goal is to maximize the fringe field by collapsing the capacitive plates to thin wires. Such a configuration is interchangeably referred to herein as a fringe capacitor or an air capacitor.

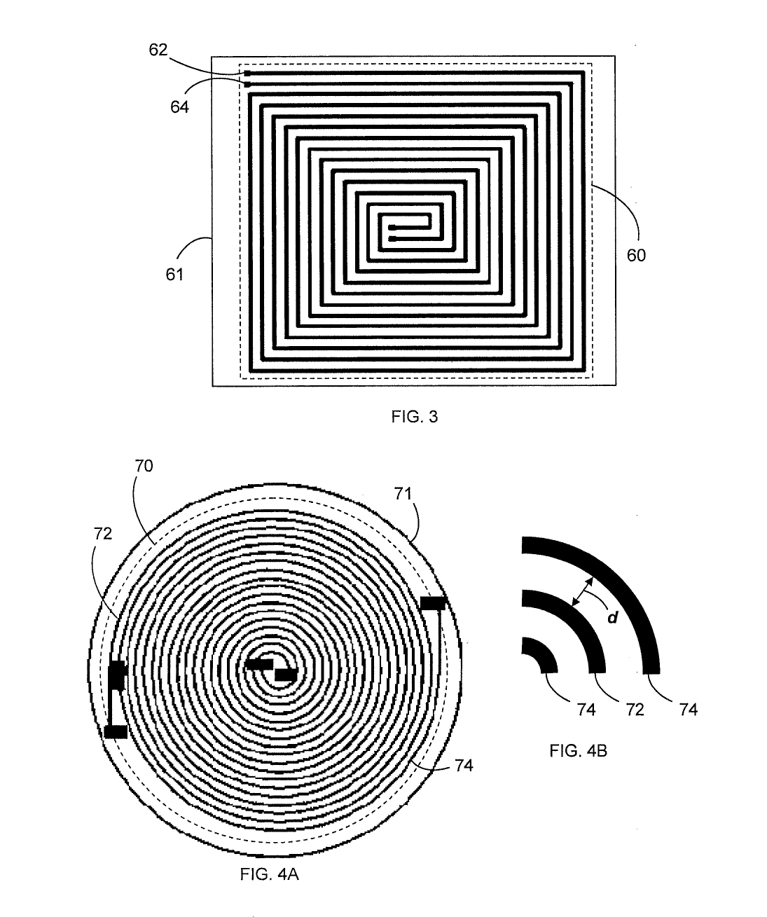

FIGS. 3 and 4A illustrate embodiments of fringe capacitor design, in which a pair of electrodes includes a first electrode 62, 72 disposed on a substrate 61, 71 a small distance from and parallel to a second electrode 64, 74, and the pair of electrodes is arranged in a spiral shape. In other embodiments, electrode arrays may be used in place of single electrodes 62, 64, 72, 74. Shapes such as the rectangle 60 and circle 70 can easily be deposited on a substrate, such as by printing the electrodes 62, 64, 72, 74 onto a circuit board as conductive tracings, as described further below. The tracings may be any suitable conductive material, such as copper or copper composites commonly used in printed circuit board design. The width of each tracing may depend on several factors, including the material composition of the tracings, the substrate, and/or any coverings, as well as the distance between tracings and the amperage of the current to be carried; typical copper trace widths in the range of about 0.01-5.0 mm, and particularly in the range of about 0.01-0.50 mm, may be used. The rectangle 60 is suitable for use in the present system, and may exhibit manufacturing efficiencies over the circle 70 due to less complicated deposition of straight circuit tracings. On the other hand, the circle 70 may have a more uniform response than the rectangle 60, achieved as described below.

Referring to FIGS. 4A-B, to give an estimate of the line charge density along the spiral of the circle 70, consider one pair of oppositely charged spirals of the electrodes 72, 74 with a spacing of d (shown in FIG. 7B) disposed at a radius r (not shown), measured from the center of the spiral (i.e., the center of the circle 70) and less than or equal to the radius of the circle 70. As long as r>>d, which is true for all regions except the very center of the circle 70, the effect of an even number of turns will cancel each other, since pairs of spiral turns will contribute equal but opposite charge. The spacing d can be any suitable distance, with the understanding that characteristics such as capacitance, required voltage, and optimal electrode width may change in conjunction with the spacing d. Additionally, a wider spacing d can facilitate thicker coatings as described below. In various embodiments, the radius r of the circle 70 at the outermost turn of the electrodes 72,74 can be between about 16 mm and about 20 mm. In various embodiments, the spacing d can be between about 1 mm and about 4 mm. To avoid the complex and potentially non-uniform charge distribution at the center of the circle 70, in some embodiments a radius from the center of the circle 70 to the innermost turn of the electrodes 72, 74 can be between about 2 mm and about 4 mm.

The net charge below any Gaussian surface (i.e., within the circle of radius r) consists only of the top-most revolution in the spiral. That net charge ΔQ is proportional to the circumference of this top-most revolution, according to the equation ΔQ=2πr*λ, where λ is the line charge density. Since the potential difference between neighboring turns is imposed by the externally applied voltage, the line charge density along any turns which are not near the center is independent from r according to the equation below.

The potential difference ΔW between adjacent turns of the spiral in the circle 70 is governed by the applied voltage and can be determined, in a symmetrical system, with the equation:

$$Δ W = \frac{Δ Q}{4 {πɛ}_{r} {ɛ}_{0}} ( \frac{1}{r} - \frac{1}{r + d} ) = \frac{d λ}{2 {ɛ}_{r} {ɛ}_{0} ( 1 + \frac{d}{r} )}$$

With the potential difference imposed by the applied voltage between consecutive spiral turns being constant, the line charge density is therefore independent of the radius. Hence, the charge distribution along the unperturbed spiral capacitor is fairly constant, resulting in a desirably constant sensitivity to permittivity anomalies introduced anywhere on the sensor.

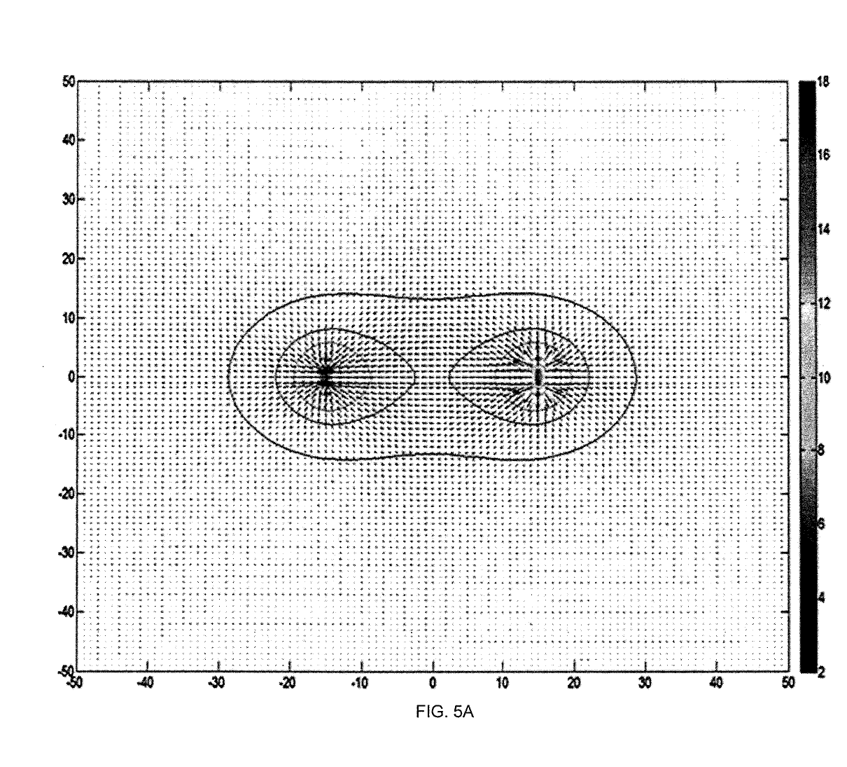

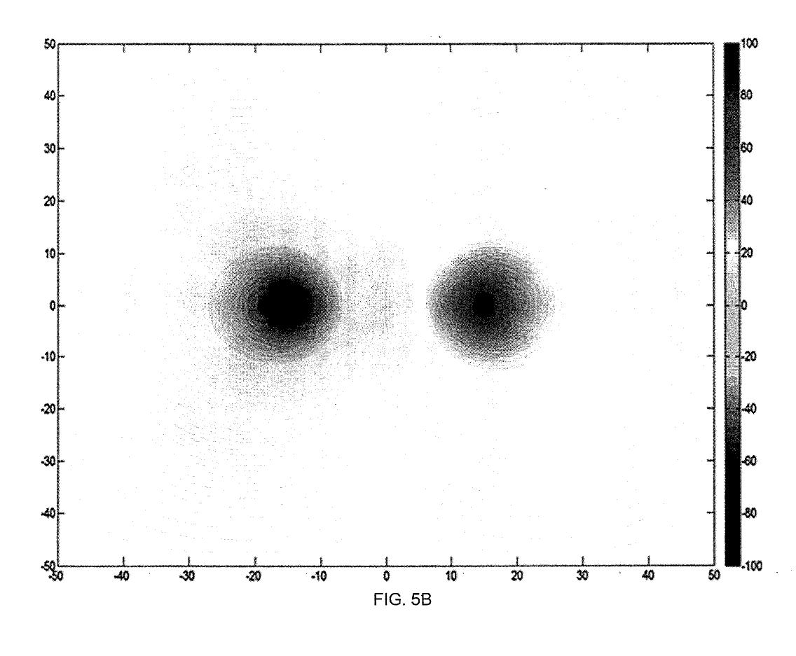

The total capacitance of the spiral design can be estimated using a similar image. Assuming the charge distribution is assembled from consecutive layers, the total energy Wₜₒₜₐₗ stored in the capacitor can be approximately calculated as:

$${W}_{total} = {\sum }_{i} Δ W = \frac{N}{2} \frac{{πλ}^{2} d}{{ɛ}_{0}} = \frac{1}{2} ( \frac{2 π N d}{{ɛ}_{0} {L}^{2}} ) {Q}^{2} ⇒ C = \frac{{ɛ}_{0} {L}^{2}}{2 π N d}$$

where L is the total length of one electrode 72, 74 of the spiral capacitor, and N is the total number of windings of both electrodes 72, 74. The total length L is approximately equal to 2πd(N+N²)/4. For larger N, the capacitance scales with the number of turns as C˜N³d, leading to an increase of the capacitance by almost an order of magnitude if the diameter is doubled. For the probe shown in FIGS. 4A-B, where N=18, the resulting capacitance is C=25 pF for d=1 mm. FIGS. 5A-B illustrate an exemplary fringe field of a capacitor such as the spiral capacitor: FIG. 5A illustrates the electric field lines (in mV/mm, axes in millimeters) around a pair of opposing conductors; and, FIG. 5B illustrates the electric potential distribution (in millivolts, axes in millimeters) around the same pair of opposing conductors. The total diameter of the probe can be 6 cm or less, and is just under 4 cm in FIGS. 4A-B, which is compatible with enclosures and market expectations of present resistivity-based precipitation sensors. In terms of measurability of the capacitance, the baseline capacitance can be greater than 10 pF, which is large compared to inherent capacitances of a few pF in the stable electronics wiring. That said, the capacitance can be measured even if it is less than 10 pF, and such capacitors are described herein. As an alternative to measuring such a low capacitance directly, the spiral capacitor can be electrically connected in parallel with one or more ordinary capacitors in order to amplify the measurable capacitance of the sensor, as described by example below. The minimum size of an “active area” (i.e., within the circle 70) of a reasonably applicable capacitance sensor of the present design is about one square inch, and the active area can be scaled up to several square feet.

Capacitive probes are ultimately read out by charging and discharging a capacitor with a certain excitation frequency, which can be up to hundreds of kHz for capacitance C values below the nF-range. For such frequencies, which are relevant in this application, the polarization and dielectric constant can be fully described by the classical Lorentz model. In it, an electromagnetic wave traveling though matter excites damped dipoles, which could be polar molecules, ions, or van der Waals clouds of large-enough molecules, as non-limiting examples. Many materials show different excitations which can give rise to polarization, such as oscillating individual atoms versus molecular dipoles, and each of these excitations is described by their own parameter set, which in the Lorentz model includes effective mass, damping constant, and resonance frequency. The resonance frequency is a function of the temperature, which is a result of certain polarization modes that literally “freeze out” at certain temperatures, regardless of the excitation frequency.

The permittivity spectrum of a dielectric medium is known to show a declining “real” permittivity with respect to increasing frequency, with larger “step” declines occurring around the resonance frequencies of the medium. At the same time, a strong increase in the dielectric loss is observed around the resonance frequencies. When designing capacitive probes to detect the presence of a substance, performance can be increased by avoiding excitation frequencies in the electronics which can cross any resonance frequencies of the probed substance. Often, there is a range of excitation frequencies used in capacitive meters or integrated circuits, and it may be important to define and constrain these. Further, the materials used to create the probes themselves, including the printed circuit board and other substrates 71 as well as any protective covers or shields, may be selected to avoid any material resonances in the chosen excitation frequency range. Lastly, the temperature behavior of the permittivity in the probe materials should be well understood and, ideally, should be as constant as possible within the selected excitation frequency range.

Capacitor design constraints can be imposed by the permittivity of water and ice, as well as by the materials of the probe surrounding the capacitor. Both water and ice have permittivity in the range from 80-120, depending on the temperature and excitation frequency. While of a similar value in the low-frequency limit, water and ice lose their strong permittivity at significantly different transition frequencies. The exact mechanism for this behavior is a subject of active scientific debate to this day, but the transition behavior is understood to be described by the Debye relaxation model. This model shows that the transition frequency is around 10 GHz for liquid water and around 10 kHz for ice. Thus, if the probing electronics use a frequency much greater than 10 kHz, which is incidentally the case for many off-the-shelf capacitance measurement solutions, the sensor would not be particularly sensitive to ice. In that case, any ice buildup would have to be melted by a sensor heater, and the sensor heater would either have to be on at all times or enabled according to a preset measurement schedule. In either case, it is not recommended to choose the excitation frequency in the same range as the Debye-relaxation for ice, since the melting of small amounts of ice would then cause large increases in capacitance which might not reflect any additional precipitation.

If sensitivity to ice is not important, excitation frequencies of greater than 20 kHz are recommended, which is implemented in most capacitance probing circuits or ICs for the 100 pF range. Conversely, if the snow sensor should be sensitive to ice, the excitation frequency should be below 10 kHz. Particularly for baseline capacitances in the 1-50 pF range, this is not achieved by standard measurement circuits or ICs, and a customized capacitance measurement circuit would have to be implemented, such as based on the discharge time across a known resistor in the range of several MΩ. However, the baseline capacitance of sensors in slab geometries covering several square feet or more would be at least in the range of several nF, and possibly μF, which is easier to measure at low-kHz (i.e., less than 10 kHz) frequencies.

Another important design criterion is the inertness of any materials used in manufacturing the sensor. That is, the permittivity must be as small as possible, and variations in the range of possible frequencies and temperatures should be minimal. This is particularly true for the substrate 71, such as a printed circuit board (PCB), on which the electrodes 72, 74 or electrode arrays are deposited, as well as for any conformal coating and any additional coatings necessary to make the sensor durable. Material selection may involve some tradeoffs in performance of one component against another. For example, the substrate 71 may be made from an FR-4 grade epoxy, which has a low relative permittivity (around 4.8) but also is a poor conductor of heat (i.e., through-plane thermal conductivity of 0.25-0.29 W/m*K). In an alternative, the substrate 71 may be made from a heat-conductive (through-plane thermal conductivity of 1.0-3.0 W/m*K) PCB; depending on the arrangement of components, this selection of material can provide better heat transfer to a receiving surface of the sensor, and can melt snow on the receiving surface faster than a comparable FR-4 implementation. In another alternative, a standard substrate 71 such as FR-4 can be used, and thermal conductivity can be improved by disposing through-holes in the substrate 71 and forming the through-holes into copper vias or filling the through-holes with an electrically insulating but thermally conductive material.

A conformal coating can be applied to protect the sensor and electronics from damage or performance changes due to ingress of moisture, dirt, or debris, or due to temperature extremes, provided the conformal coating provides, or does not negate, a predictable dielectric constant over the relevant temperature band and within the sensor range. Suitable conformal coatings include any conformal coating that has a low permittivity-temperature dependence, including without limitation silicon and epoxy. The conformal coating can be applied to either side or both sides of the substrate 71 to protect the electronics and conductive connections thereon, e.g., from condensation inside or outside of the probe housing. The conformal coating can be applied with a thickness within a range of about 25-250 μm.

Additionally or alternatively, an outer coating may be applied to protect the sensor and other electronics, and further to protect the conformal coating if there is one. An example outer coating material with desirable permittivity and other properties is polytetrafluoroethylene (PTFE), which has among the lowest permittivity (2.0-2.1) found in plastic materials. As a fluoropolymer, PTFE exhibits suitable thermal, mechanical, chemical, and ultraviolet resistances to maintain its integrity in any outdoor deployment environment. PTFE also has no phase transitions in the critical temperature range (i.e., a cold outdoor environment, between −20 degC to +5 degC) and in the frequency range of <1 MHz. Expected variations in permittivity are about 0.02, or less than 1%, in the target frequency range. It is noted that PTFE has phase transitions outside the target temperature range: two major phase transitions with characteristics of glass transition temperatures at −100 degC and +127 degC, associated with freezing out interactions among crystalline domains and between crystalline and amorphous domains, which can create complex permittivity-versus-temperature behavior; and a crystalline transition around room temperature (+20 degC) that does not significantly affect the critical material behaviors.

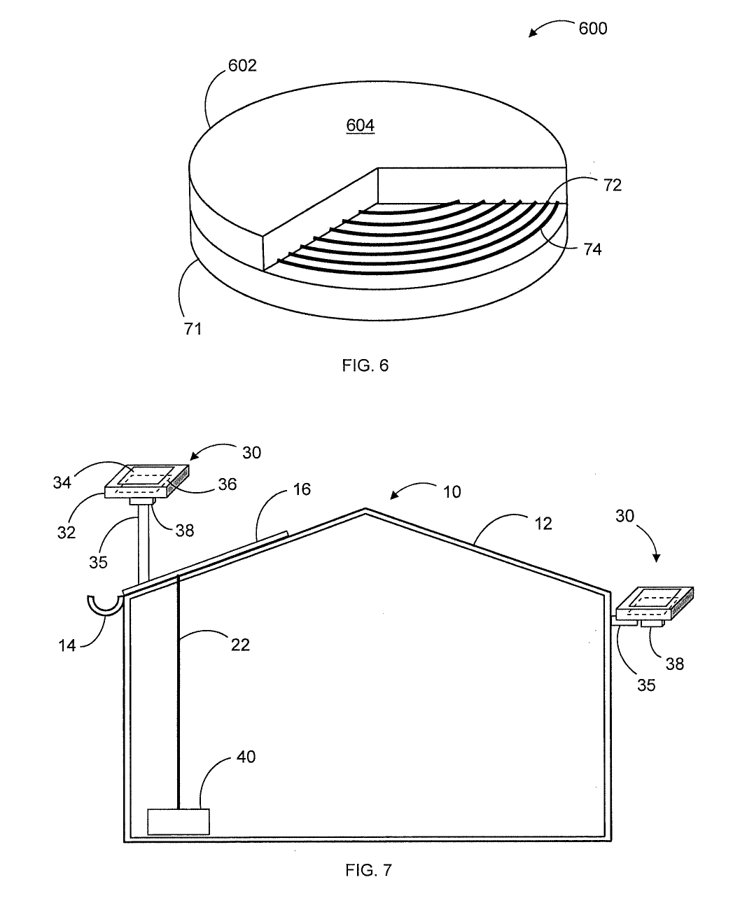

Some or all capacitive regions of the probe can be coated with a layer of PTFE at a thickness of about 0.1-3 mm to improve the durability of the sensor. FIG. 6 illustrates an exemplary embodiment of a sensor 600 having the substrate 71 and electrodes 72, 74 of the spiral capacitor of FIG. 4A. A PTFE cap 602 can be deposited over the electrodes 72, 74, covering or encasing the electrodes 72, 74 to protect them from galvanic corrosion and other environmental damage. The cap 602 can have the same perimeter shape as the substrate 71, and the perimeters of the substrate 71 and cap 602 can be flush with each other; thus, the substrate 71 and cap 602 can be circular, concentric, and can have the same diameter, as illustrated. In other embodiments, the cap 602 and substrate 71 can have different shapes, and the cap 602 can be wider or narrower than the substrate 71.

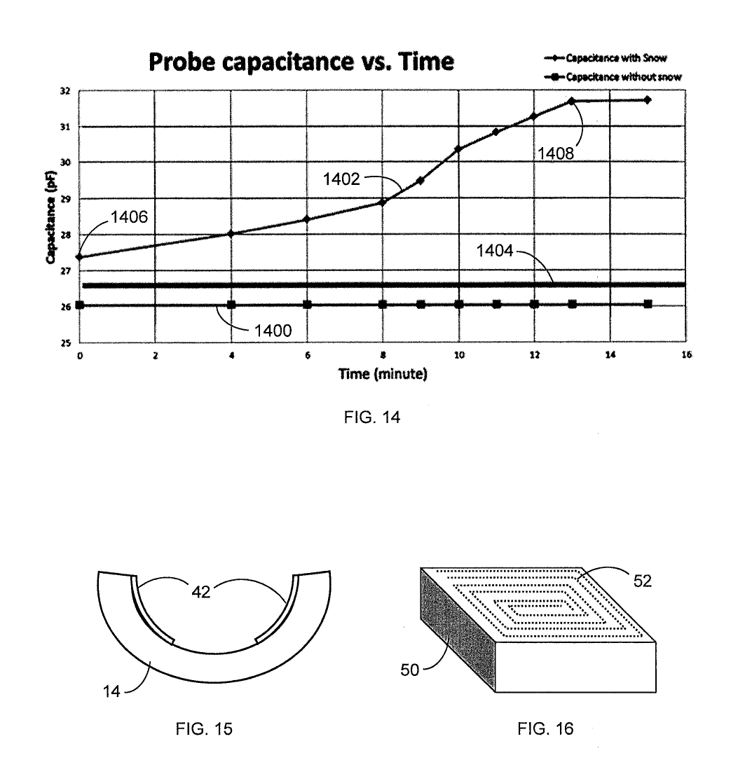

The cap 602 can form a receiving surface 604 that is substantially planar or slightly convex, and becomes the surface of the sensor 600 that is directly monitored by the fringe capacitor. That is, the surface 604 lies within the fringe field generated by the electrodes 72, 74, and is exposed to the environment when deployed, such that accumulation of high-permittivity materials, specifically water, snow and/or ice, on the surface 604 significantly changes the capacitance of the spiral capacitor. The opposing side of the cap 602 can be in contact with the electrodes 72, 74. This side can be etched, forming one or more grooves having a width, depth, and pattern that corresponds substantially to the electrodes 72, 74. The etching can optimize the surface area of contact between the cap 602 and the substrate 71, which can be bonded together with a suitable adhesive. For purposes of demonstrating a suitable but non-limiting ratio of material widths and thicknesses for a circular sensor 600 for detecting snow, the dimensions of an exemplary sensor 600 (which produced the capacitance chart of FIG. 14) are as follows: diameter of substrate 71 and cap 602 is 60 mm; thickness of substrate 71 is 1.6 mm; thickness of cap 602 is 0.5 mm; diameter of sensor active area is 37-38 mm; electrode 72, 74 width is 0.02 mm; spacing d is 2 mm; and distance from the center of the substrate 71 to first turn of an electrode 72, 74 is 3.5 mm.

For optimal performance, the specific PTFE sourced for the probe should have no variations or impurities that introduce any complex behavior in permittivity versus temperature in the target range. That said, the PTFE can be a PTFE composite with a filler material, such as glass microfibers or a ceramic material, that enhances favorable properties of the PTFE while providing the desired uniform permittivity. In one example, the cap 602 can be an RO3000 series ceramic-filled PTFE made by Rogers Corporation, which has a coefficient of thermal expansion matching that of copper, so that the cap 602 maintains dimensional stability with respect to copper tracings of the sensor. In another example, the cap 602 can be an RT/DUROID 5870 glass microfiber reinforced PTFE also made by Rogers Corporation, which has randomly-oriented fibers distributed throughout and reinforcing the material.

In terms of excitation frequencies, PTFE shows constant permittivity in the desired frequency range, and small variations with respect to the possible variations in temperature. PTFE also exhibits suitable thermal conductivity for delivering the heat generated by the sensor heater 36 to the snow or ice on the sensor 34. Various epoxies may also be used in addition to or instead of PTFE as an additional coating material, provided the epoxy has similar UV resistance and hydrolytic stability to PTFE. Non-limiting examples include two-part epoxies with high chemical resistance, such as EP21AR and similar epoxies manufactured by Master Bond, Inc., and materials rated for outdoor use in the solar industry, including UV-resistant moisture barrier adhesives such as the SOLARGRIP materials manufactured by AI Technology, Inc. Some such epoxies can be deposited in liquid form and harden to form the cap 604.

Capacitive Probe Design

Capacitive probes can have different form factors commensurate with different applications. Referring to FIG. 7, an aerial capacitive probe 30 (shown out of scale to illustrate detail) can have a sensor housing 32 containing or providing support for an aerial capacitive sensor 34. The aerial capacitive probe 30 can be elevated above the roof 12 surface by a structural support 35. This advantageously spaces the sensor 34 away from any surrounding surfaces that may affect the sensing capabilities of the sensor 34. In some embodiments, the height of the support 35 can be determined by environmental factors such as frequency of high winds, regulatory factors such as building codes, equipment factors such as selection of light source intensity or sensor sensitivity, and/or aesthetic factors. In other embodiments, the aerial probe 30 can also be mounted to the side of a building 10, and the support 35 can serve as a mounting bracket or mounting arm; the aerial probe 30 and support 35 in this design can be similar in form factor to a lamp or a dome camera. In either case, the elevation by the support 35 can provide space to mount additional components of the probe 30, described below, under the housing 32 so as not to obscure the sensor 34 or occupy additional surface area of the roof 12.

The housing 32 catches falling or blowing snow on a surface monitored by the sensor 34. That is, the surface can be within the fringe field of the capacitor on the sensor 34, as described further below. The sensor 34 detects the snow, which is then melted off by a sensor heater 36 mounted within the housing 32 (as illustrated), or below and attached to the housing 32. In some embodiments, the sensor heater 36 can directly heat the receiving surface or an adjacent surface that conducts heat to the receiving surface. For example, a heating element may be attached to the receiving surface or to the structure that includes the receiving surface; that is, if the surface to be heated is external to the housing 32, the heating element can be attached to the underside or inner surface of the housing 32 wall, such that heat from the heating element is conducted through the housing 32 to the receiving surface, melting the snow. Additionally or alternatively, the sensor heater 36 may be mounted such that the sensor heater 36 heats the interior space within the housing 32. The housing 32 can contain temperature-sensitive electronics, such as the probing electronics of the sensor 34, communication interfaces such as universal serial bus (USB) or wired or wireless network interfaces, and electrical connections to a power supply, various controllers, and other components. In such embodiments, the sensor heater 36 can heat the interior space of the housing 32 to a temperature that will melt the snow but does not cause thermal damage to the electronics. In other embodiments where the housing 32 does not house electronics in the interior space, the sensor heater 36 may heat the interior space to a high temperature, such as 75 degrees C. or higher, that more quickly melts the snow. The sensor heater 36 can be controlled as described below, and can be either always on, activated at predetermined intervals, actuated by output values of the sensor 34, and/or regulated according to the interior and/or exterior temperature of the aerial probe 30.

Another difference in probe design affected by form factor is the selection of the sensor heater 36. In some embodiments where the “active area” of the capacitance sensor is several square inches, a rigid or flexible planar silicone heater can be used. In embodiments where the active area is smaller, the sensor heater 36 can be one or more discrete resistors connected to the sensor's electrical circuit or another electrical circuit. Resistors can provide equally distributed heating across the sensor area and can also be small enough to fit inside the housing 32 or another probe enclosure to be shielded from the environment. Another embodiment can include a fan (not shown) located inside the housing 32. The fan can be any small electronics fan having a suitable size, power consumption, and output for circulating air in the housing 32. The fan can provide stable and equal temperature throughout the housing 32, which is advantageous for temperature measurements in the housing 32. In some embodiments, the fan can be positioned near the sensor heater 36 in order to circulate the heat produced by the sensor heater 36 throughout the housing 32. In other embodiments, one or more of the probing electronics and the satellite controller 38 and associated electronics, and optionally the fan, may be in a separate controller from the sensor.

A satellite controller 38 can be integrated into the aerial capacitive probe 30. In some embodiments, the satellite controller 38 can be mounted below or inside (i.e., in the interior space of) the housing 32 to partially or fully protect the satellite controller 38 from the environment. The satellite controller 38 can be electrically connected to one or both of the sensor 34 and the sensor heater 36, and can be configured to communicate with the primary controller 40 of the system. The satellite controller 38 can perform several functions, including without limitation: read the sensor 34 status; read the ambient temperature; perform integrity checks on the probe 30 (e.g., operational detection for the sensor 34 and/or sensor heater 36); activate and/or deactivate the sensor heater 36 based on the sensor 34 status and/or temperature readings from interior and/or exterior temperature sensors; and, communicate with the primary controller 40 to receive instructions and/or share data. The satellite controller 38 can use any suitable communication protocol to communicate in a wired or wireless manner with the sensor 34, sensor heater 36, and/or primary controller 40, such as the TIA-485 protocol. The satellite controller 38 can include a microcontroller and other integrated or discrete circuits as needed to perform its operations, such as power relays, communication interfaces, signal converters, RAM or other data storage devices, and other peripherals. The microcontroller may have integrated RAM and analog-to-digital converters in order to read and store sensor 34 output over the course of hours or days. A suitable example microcontroller for the satellite controller 38 is the LPC 1768 ARM-architecture microcontroller manufactured by NXP Semiconductors N.V., which has onboard interfaces for communicating with other controllers and components via I2C, USB, Ethernet, and other protocols.

Capacitance sensors that can be interrogated remotely via I2C or through an analog output or other protocols exist, and can be used in the presently described systems. In some embodiments, other measurements in the vicinity of the sensor 34 can be taken. These can include one or more temperature measurements. An interior temperature can be monitored with an interior temperature sensor disposed in the interior space of the housing. The interior temperature sensor can communicate with the satellite controller 38 via wired or wireless connection. The interior temperature sensor can include any suitable temperature sensing device; as a non-limiting example, the LM34CZ temperature sensor manufactured by Texas Instruments, Inc., may be selected due to the following advantageous features: direct calibration; linear 10.0 mV/° F. scale factor; 1.0° F. accuracy assured (at 77° F.); rated for full −40° C. to 110° C. range; suitable for remote applications; low cost due to wafer-level trimming; operational from 5 to 30 volts; less than 90-μA current drain; low self-heating (0.18° F. in still air); nonlinearity variation of typically only ±0.5° F.; and low-impedance output of about 0.4Ω for a 1-mA load.

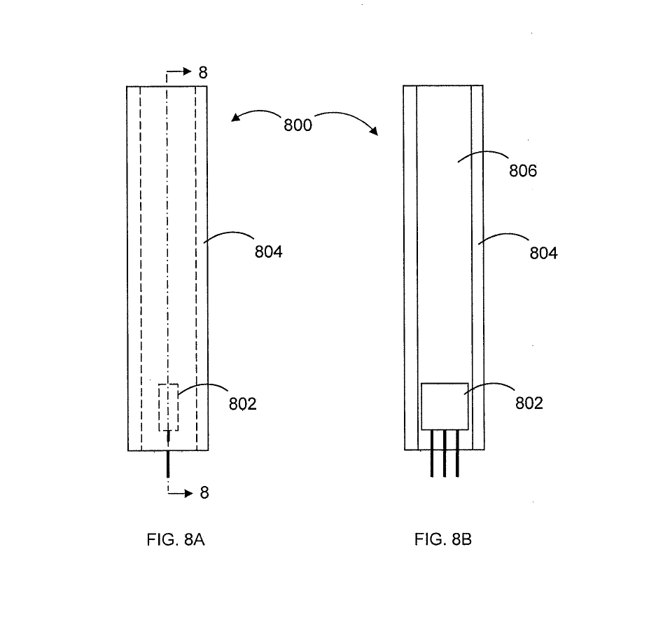

An exterior temperature of the housing 32 can be monitored with an exterior temperature sensor disposed outside of the housing 32 and in communication with the satellite controller 38 via wired or wireless connection. The exterior temperature sensor can include any suitable temperature sensing device; as a non-limiting example, the exterior temperature sensor may be the LM34CZ temperature sensor described above. The exterior temperature sensor may further include shielding structures disposed around, and potentially encasing, the sensing device to protect the sensing device from the environment. FIGS. 8A-B illustrate an exemplary exterior temperature sensor 800. A sensing device 802, such as the LM34CZ, can be contained in an encasement 804 made of a durable, water-resistant, and heat-tolerant material, such as styrene. In some embodiments, the encasement 804 may be solid throughout, and may have a cavity disposed within for containing the sensing device 802. In other embodiments, the encasement 804 may be a hollow tube partially or completely filled with a heat-conductive filler 806, such as an epoxy. In this construction, the encasement 804 protects the sensing device 802 from exposure to weather while also regulating the temperature detected by the sensing device 802; that is, the encasement 804 may maintain the temperature within the sensing device's 802 range at the actual ambient temperature regardless of exposure to direct sunlight or accumulation of snow or ice on the exterior of the encasement 804. The sensing device 802 may alternatively be coated in a material that provides protection and thermal conductivity.

In an embodiment, the sensing device 802 leads may be connected to a terminal block (not shown) mounted on the aerial probe, such as on the housing. In another embodiment, the sensing device 802 leads may be connected to weather-resistant wires (not shown) that connect to a satellite controller. In yet another embodiment, the sensing device 802 may connect to a wireless transmitter (not shown) that is also protected by the encasement 804 or another shielding structure, and is in communication with the satellite controller. The exterior temperature sensor may be attached to an exterior surface of the housing 32, or placed some effective distance from the housing 32; since the measured ambient or exterior temperature can be used to control the probe 30, the exterior temperature sensor can be placed in the vicinity of the probe 30 to most accurately detect the relevant temperature.

Referring again to FIG. 7, still other measurements that can be taken in the vicinity of the sensor 34 include measurements of electric current, such as the input current into the microcontroller, or the sensor heater current when a sensor heater is used. For example, the sensor heater current can be used by the satellite controller to determine the operational state of the sensor heater during the self-testing procedures described below. In another example, the microcontroller can detect the input current, fan current, sensor heater current, or another current, and determine that current is flowing when there should be no current, or determine that the current is above or below a threshold amperage; this may indicate a failure condition, and the microcontroller can generate an alert and send the alert to a user device or to the main controller 40 to notify a user that the probe 30 is malfunctioning.

In order to accurately probe the capacitance, the readout electronics can be in close proximity (e.g., less than 0.5 m separation) to the capacitor. The satellite controller 38 can include the capacitance-measuring (i.e., readout) electronics, and in such embodiments is best mounted inside the housing 32 in the immediate vicinity of the sensor 34. The satellite controller 38 can be configured to conduct multiple analog measurements. The satellite controller 38 can transmit some or all of the recorded measurements to the primary controller 40, and further can write the recorded values to its own flash memory. In other embodiments, the capacitance-measuring electronics may be contained within the housing 32 and electrically connected to the satellite controller 38, which may be outside the housing 32. The readout electronics can be disposed on a dedicated PCB, or on the same PCB as the capacitor but spaced a suitable distance from the capacitor so that any noise produced by the readout electronics does not interfere with the capacitor operation. Any suitable capacitance measuring integrated or discrete circuits may be used for the readout electronics, such as a capacitance-to-voltage integrated circuit that has an operating range including the capacitance range of the sensor 34, as described below. The readout electronics can be electrically insulated from the capacitor except as needed to detect the capacitance.

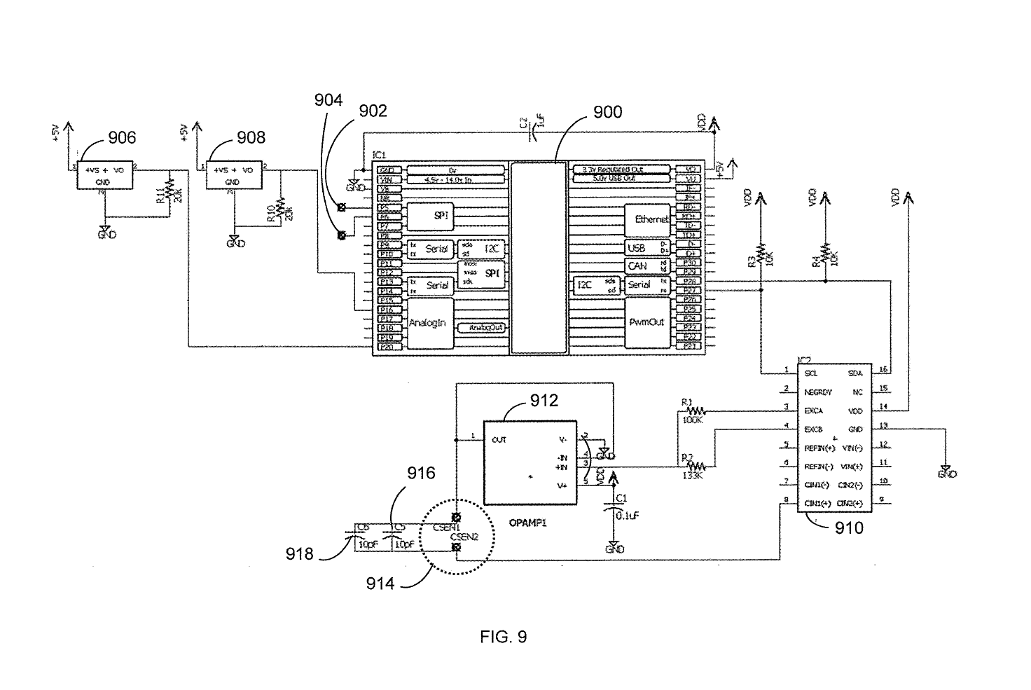

In light of the above, FIG. 9 illustrates an exemplary circuit connection of the components of a capacitive probe. A microcontroller 900 can be disposed on a PCB or other substrate of the satellite controller. The LPC 1768 described above is shown by example. The microcontroller 900 can connect to activation circuits of a sensor heater 902 and a fan 904 through a suitable interface, such as SPI. The microcontroller 900 can connect to an exterior temperature sensor 906 and an interior temperature sensor 908, each illustrated as a LM34 described above, via an analog interface. For snow sensing, the microcontroller 900 can connect to a converter 910 that measures capacitance and converts the measured capacitance value to an equivalent analog (i.e., voltage) or digital value. Suitable converters 910 include the AD7746 capacitance-to-digital converter manufactured by Analog Devices, Inc., and the CAV444 capacitance-to-voltage converter manufactured by Analog Microelectronics GmbH, and also include any suitable IC or combination of discrete circuit components that can measure capacitance and communicate with the microcontroller 900. The converter 910 is illustrated as an AD7746 for example, which advantageously can sense capacitance in the applicable range and performs the digital conversion at 24-bit resolution.

The converter 910 can provide the excitation frequency to the capacitive sensor. In the illustrated embodiment, the converter 910 connects, via its excitation outputs, to the input terminals of an operational amplifier (“op-amp”) 912 placed near the sensor 914. The AD8515 op-amp manufactured by Analog Devices, Inc., is shown by example, but any op-amp having a suitably small footprint and very low noise, so as not to disrupt the sensor 914, while also driving a high capacitive load without external compensation, may be used. The op-amp 912 applies the frequency-modulated voltage to the input (i.e., first electrode) of the sensor 914, while the output (i.e., second electrode) of the sensor 914 connects back to the input of the converter 910. The sensor 914 can have a capacitance range (i.e., a range between the baseline capacitance when moisture is not present, and a detected capacitance when moisture is present) of less than 10 pF. Additionally, or alternatively, the baseline capacitance can be below 10 pF. With such low capacitances, it can be advantageous to electrically connect additional capacitors to the circuit in parallel with the sensor 914 in a manner that increases the sensor's 914 baseline capacitance. For example, a 20 pF capacitance connected in parallel with the sensor 914, provided by two 10 pF capacitors 916, 918 in FIG. 9, can improve reliability of the sensor 914 signal by increasing the baseline capacitance to about 30 pF. This can make the sensor 914 signal less susceptible to noise and/or can push the detectable capacitance range into the detection ranges of different models of converter 910. Additionally, when the sensor 914 range is at or below 10 pF, the capacitance of lead wires, if any, attached to the electrodes of the sensor 914 can overwhelm the sensor's 914 reported values; lead wires having much smaller capacitance can be used.

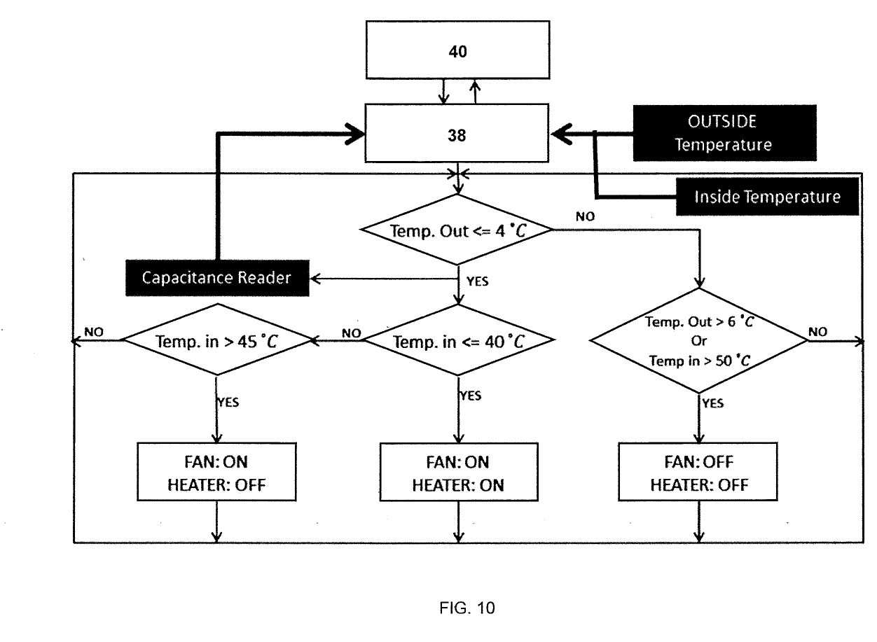

Referring to FIG. 10, the satellite controller 38 can be configured to perform monitoring and testing functions by executing program instructions. These program instructions can be stored by the satellite controller 38, such as in firmware stored in a memory of the microcontroller. Additionally or alternatively, the satellite controller 38 can receive the program instructions from another device, such as a primary controller 40 or another satellite controller of the system. FIG. 10 illustrates one self-test of the capacitive probe; this test determines the proper operational states of the sensor heater and, optionally, a fan installed in the probe housing. Receiving the interior and exterior temperatures, for example from the interior and exterior temperature sensors described above, the satellite controller 38 can compare the current interior and exterior temperatures to one or more thresholds for the interior and exterior temperatures, and can activate and deactivate the fan and the sensor heater based on these values.

In the illustrated example, the exterior temperature must be 4 degC or below for the satellite controller 38 to activate a capacitance reading and process the detected capacitance data from the capacitive sensor. If this threshold is not met, the satellite controller 38 (i.e., the microcontroller) will not communicate with the capacitance reader (e.g., the digital converter described above). Further, if the exterior temperature is over 6 degC or the interior temperature is over 50 degC, the satellite controller 38 will turn off the fan and the sensor heater if they are operating. If the exterior temperature is 4 degC or below, and the interior temperature is 40 degC or below, the satellite controller 38 can activate both the fan, to circulate air in the housing, and the sensor heater, to increase the interior temperature to a level that will melt any snow on the probe. If the interior temperature is over 45 degC, it is warm enough to melt snow and the satellite controller 38 can turn the sensor heater off and turn the fan on to circulate air. The satellite controller 38 can further perform alerting functions, such as transmitting temperature, fan operation, and heater operation statuses to the primary controller 40. Additionally or alternatively, the probe can include status indicators, such as LEDs disposed through the housing and/or onboard the satellite controller 38, for alerting a user to the status of the probe. The algorithm of FIG. 10 can further include detection of additional failure modes. For example, the satellite controller 38 can detect that the interior temperature is over 75 degC and deactivate the probe on the assumption that the sensor heater and/or fan has failed.

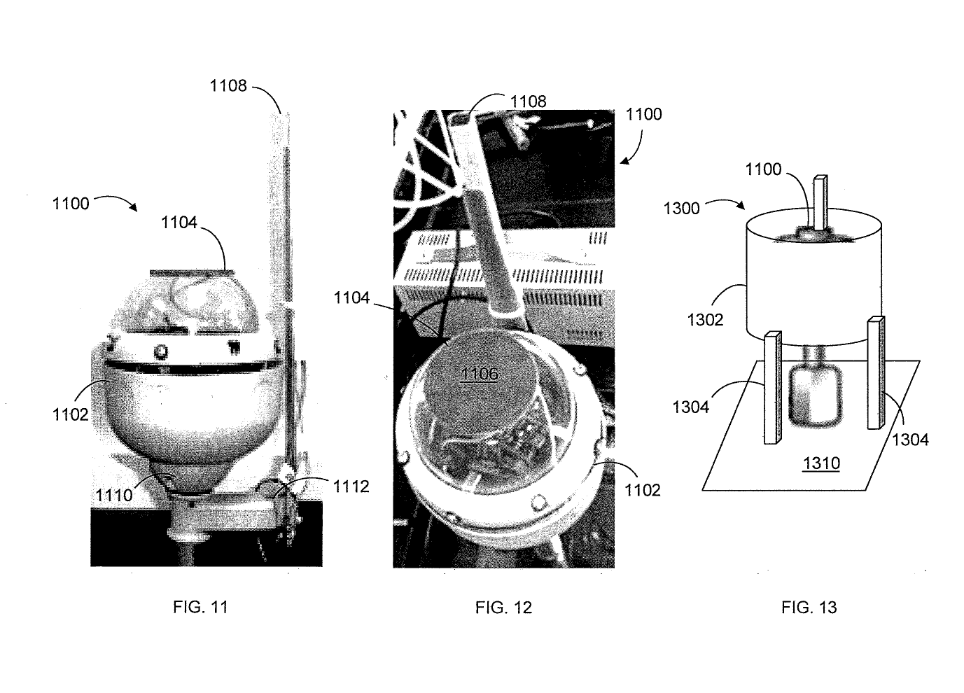

Referring again to FIG. 7, a substantially flat or planar housing 32 can be mounted at an angle with respect to the ground, allowing water/melted snow to flow off of the receiving surface. FIGS. 11 and 12 illustrate another embodiment of an aerial capacitive probe 1100. The probe 1100 can include any of the structures, components, communication channels, and the like, as described above with respect to other embodiments of the capacitive probe. A housing 1102 of the probe 1100 can be mounted on a vertical support 1110. For mounting to a vertical surface, such as a wall, the probe 1100 can further include a horizontal support 1112 that attaches to the housing 1102 or to the vertical support 1110 (as shown in FIG. 11). The housing 1102 can have an unobtrusive size, similar to a floodlight or a dome security camera. The housing 1102 can be durable for exterior use, and can be a waterproof (e.g., IP66 rated) enclosure for protecting the electronics within. The housing 1102 can be made from a correspondingly suitable material, such as steel, aluminum, or plastic; a plastic enclosure may be preferred in some embodiments because it can retain more heat inside the housing 1102 than a non-insulated steel or aluminum housing can. In other embodiments, the housing 1102 can be insulated.

A sensor 1104 can be mounted to the housing 1102 so that the receiving surface 1106 is exposed to the environment. The sensor 1104 can be mounted at an angle with respect to the ground, allowing water/melted snow to flow off of the receiving surface. An exterior temperature sensor 1108, such as the temperature sensor 800 of FIGS. 8A-B, can be mounted to the housing 1102 as well. Any seams around the sensor 1104, and around any other aperture through the housing 1102 (e.g., wire passages, LED mounts, etc.), can be sealed with watertight gaskets (not shown). Referring to FIG. 13, a wind shield 1300 can be positioned around the probe 1100 (or another aerial probe in accordance with the disclosure). The wind shield 1300 can be a cylinder 1302 elevated from a mounting surface 1310 by one or more legs 1304. The height and diameter of the cylinder 1302 can prevent turbulence from affecting the probe 1100, while providing airflow and ingress of the snow. Debris, such as leaves, is passed through the empty space between the cylinder 1302 and the probe 1100 and falls away.

FIG. 14 demonstrates an exemplary curve of capacitance of the probe 1100 of FIG. 11 over time. Plot 1400 is the capacitance of the sensor 1104 with no snow or other moisture present on the receiving surface 1106. Plot 1402 is the capacitance of the sensor 1104 with snow present. Specifically, at time T=0 the point 1406 represents the presence of relatively solid snow on the receiving surface 1106. As the snow melts (i.e., by the sensor heater of the probe 1100), the capacitance increases until the snow is completely melted to water on the receiving surface 1106, at point 1408. The plot 1402 indicates a 64.44% increase of capacitance of the present spiral capacitor sensor when water is present on the receiving surface 1106. Considering this large increase, the probing electronics can detect a very small amount of snow on the receiving surface 1106—in particular, when a capacitance-to-digital converter is used at 24-bit resolution, it is contemplated that the present device can detect capacitance variations caused by each single snowflake falling onto the receiving surface.

A detection threshold value 1404 may be stored (e.g., in a microcontroller memory) or retrieved by the satellite controller of the probe 1100 to determine the capacitance at which the satellite controller will report that snow or moisture is present. The detection threshold value may be a predetermined value that is higher that the baseline capacitance of the sensor 1104 at an excitation frequency. Alternatively, the satellite controller may store or retrieve a baseline capacitance value for comparison to the detected capacitance value.

Non-limiting examples of other form factors for probe sensors include, as illustrated in FIG. 15, one or more strip sensors 42 for gutter 14 applications, and, as illustrated in FIG. 16, concrete slabs 50 with embedded probes 52 for driveways, walkways or roof deployment. The main differences among form factors are the geometric shapes and surface areas of the capacitive sensors. This implies that the capacitance ranges to be measured may be different for the different applications, leading to different requirements for sensing circuits associated with each sensor. Details regarding the electrical implementation of the capacitive probe are described herein with respect to the aerial probe 30 that can be deployed as illustrated in FIG. 7, but suitable modifications to the electrical implementation to accommodate other capacitive probe designs are contemplated and can be derived from the disclosure without undue experimentation.

Color Sensing

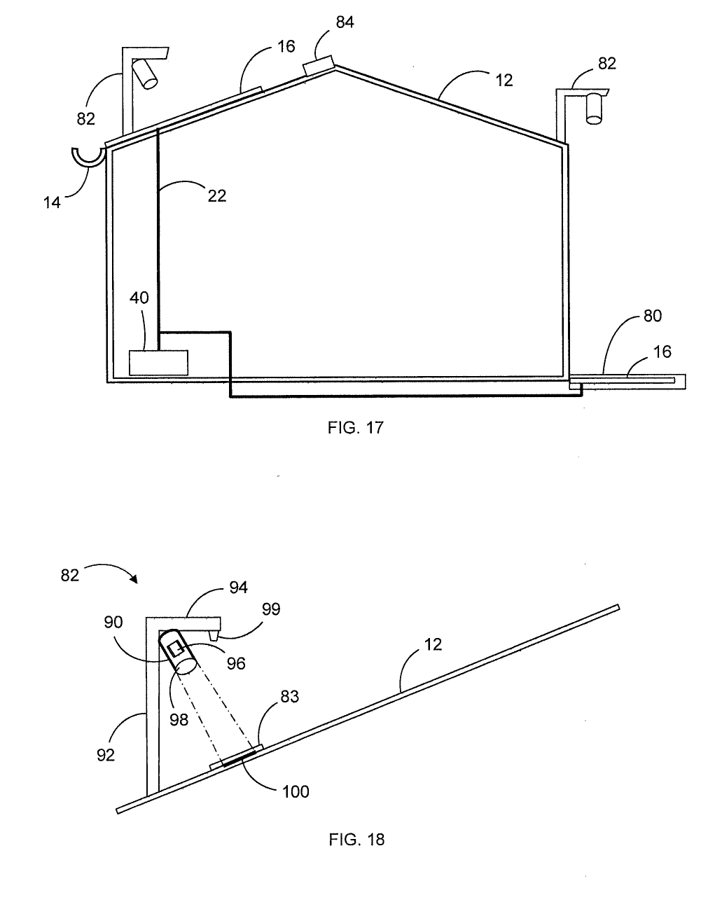

Previous snow melting systems can also be improved using data from a sensor that checks whether a surface is clear of snow by measuring the spectral distribution of light reflected off of a discrete area of the surface. Referring to FIG. 17, the present system can include a light probe 82 that includes an optical sensor, such as an RGB sensor, that is suitable to detect the difference in reflected light between snow cover of a surface and the surface itself. Light probes 82 can be positioned to detect snow, and lack thereof, on a roof 12, a driveway 80, and any other surface that is heated by a heating cable 16 or other heating element. Using the detection configurations described below, the light probes 82 can detect when a heat trace snow melting system has succeeded in melting the snow cover, and can signal a satellite controller 84 or the primary controller 40 to turn off the heating cables 16. The light probes 82 can also be used to detect snow accumulation and signal for the heating cables 16 to be turned on, or any of the above-described sensors (e.g., sensor 18 of FIG. 1 or sensor 34 of FIG. 7) may be used to determine the presence of snow and/or ice and turn on the heating cables 16.

The satellite controller 84 can be in electrical communication with the light probes 82 and can be attached to or remote from the light probes 82. The satellite controller 84 can be configured to communicate with the primary controller 40 of the system. The satellite controller 84 can perform several functions, including without limitation: collect and/or read the statuses of color sensors in the light probes 82; read and/or measure the ambient temperature; perform integrity checks on the light probes 82 and their components; activate and/or deactivate light probe 82 heaters and light sources; and communicate with the primary controller 40 to receive instructions and/or share data. The satellite controller 84 can use any suitable communication protocol to communicate in a wired or wireless manner with the light probes 82 and primary controller 40, such as the TIA-485 protocol. The satellite controller 84 can transmit some or all of the recorded measurements to the primary controller 40, and further can write the recorded values to its own flash memory. The satellite controller 84 can include a microcontroller and other integrated or discrete circuits as needed to perform its operations, such as power relays, communication interfaces, signal converters, RAM or other data storage devices, and other peripherals. The microcontroller may have integrated RAM and analog-to-digital converters in order to read and store sensor output over the course of hours or days.

Existing color sensors that can be interrogated remotely via I2C or another protocol, or read out as an analog signal through an analog-to-digital converter, can be used in the presently described systems. In such embodiments, the satellite controller 84 or the primary controller 40 can perform sensor polling, in which the polling device sends an inquiry (e.g., via transmission of a data packet) to the color sensor and the color sensor is configured to respond by sending its own data packet containing the sensor status and other desired information. In other embodiments, the light probe 82 can include its own microcontroller for polling and configuring the color sensor, and can store sensor data in its own memory and transmit the data to the satellite controller 84 or the primary controller 40.

FIG. 18 illustrates an embodiment of a light probe 82 installed on a roof 12. A sensor housing 90 is disposed in a fixed position above the roof 12 by attachment to one or both of a vertical support 92 and a horizontal support 94. The sensor housing 90 can be many feet above the area of the roof 12 to be monitored; suitable ranges can depend on the type of building being monitored. For example, the sensor housing 90 clearance (i.e., distance from the roof 12) for a typical residential home can be between one and five feet, while the same clearance for a large commercial building can be much larger. The sensor housing 90 contains a color sensor 96 that receives light through an aperture in the sensor housing 90. The sensor housing 90 and color sensor 96 can be positioned so that the light received on the color sensor 96 is reflected from a monitored area 100 on the surface of the roof 12. The monitored area 100 can be defined by a field of view through the aperture, which can be modified by a lens 98 disposed in the aperture, and the distance from the housing 90 to the roof 12. A convex lens 98, for example, can expand the field of view through the aperture. Otherwise, the lens 98 can focus the reflected light onto the color sensor 96.

The light probe 82 can further include one or more powered light sources 99 attached to the vertical support 92 or horizontal support 94 and arranged to illuminate the monitored area 100. Illumination of the area 100 via the light sources 99 allows the color sensor 96 to operate at night and in low-light conditions. Suitable light sources 99 include individual or arrays of light-emitting diode bulbs, fluorescent bulbs, halogen bulbs, and the like. The desired wattage range can depend on the sensitivity of the color sensor 96 and characteristics, such as color spectrum, of the light source 99 used. For the RGB sensor described below, a light source 99 of at least about 20 W provides reliable nighttime operation.

Some or all of the sensor housing 90, color sensor 96, lens 98, and other components of the light probe 82 may be heated by one or more heating elements (not shown) to maintain the color sensor 96 and electronics within an operating temperature range. The heating can also evaporate moisture on the lens 98 to reduce or eliminate interference of such moisture with the collected spectral data.

As described further below, some monitored surfaces (i.e., roof 12) may be colored too similarly to snow or may scatter light too inefficiently for the color sensor 96 to detect the presence or absence of snow. The light probe 82 can therefore further include a reference overlay 83 that is placed over the monitored surface (i.e., roof 12) in the monitored area 100. The reference overlay 83 can be a thin, planar sheet made of a suitably reflective, thermally conductive, weather-resistant material, and can be colored to contrast significantly with snow. The reference overlay 83 can be flexible or rigid, and can be secured to the monitored surface with a suitable adhesive or mechanical fastener. For example, the reference overlay 83 can be secured to the roof 12 with glue, nails, staples, etc. It will be understood that folds or curvature of the reference overlay 83 may affect the spectrum of light reflected from the reference overlay 83 into the color sensor 96, so a flexible reference overlay 83 can advantageously be secured flat against the monitored surface. Experimental observations indicate that, for an RGB sensor as described below, a blue or red reference overlay 83 is preferred. Where heater cables 16 are used, the reference overlay 83 can be placed over or under the heater cables 16 in a manner that does not alter the detectable color of the reference overlay 83 to a degree that interferes with the light probe 82 operation. If a large-area heating device, such as a slab heater, is used in the system, the reference overlay 83 can be placed above the heating device to ensure proper detection by the light probe 82 of the reference overlay 83 color.

Color Sensor Selection

The color sensor 96 may be any sensor suitable for detecting color differences in the visible spectrum of light reflected off of the monitored area, considering the operating environment (in the extreme, temperatures below −20 degC, high winds, and high moisture), varying light conditions due to time of day and weather, and low light reception and data generation and processing requirements for economically operating a snow melting system. The color sensor 96 should be at least capable of detecting snow, represented by substantially white light, and lack of snow, represented by reflection of non-white light, reflected from the monitored area. In terms of complexity of optical detection methods for snow, RGB sensors are more complex than simple photodiodes, which measure the albedo of a surface, and less complex than sophisticated imaging systems based on CCD or CMOS chips. Due to the daily, seasonal and weather variations of lighting conditions, a simple albedo sensor may not be sufficient to reliably detect snow cover. Conversely, a full CCD or CMOS imaging system yields too much data: automated image recognition algorithms capable to detect snow cover could be used but are beyond the necessary scope of the hardware to be employed.

RGB sensors are photodiode arrays with different sensitivities to parts of the visible spectrum. The differences in sensitivities are achieved through either a combination in the array of different photodiodes, or use of the same photodiode with different color filters. While there is no universal definition for the ranges of sensitivity for the three channels in an RGB sensor, they roughly correspond to the wavelengths {Red, Green, Blue}={>600 nm; 500-600 nm; <500 nm}. Each photodiode element is a reverse-biased pn junction, with positive potential at the p-side, that is enhanced in its optical sensitivity through a wider intrinsic region, widening the photo-sensitive depletion region. Incident photons in the depletion layer can be absorbed and create electron-hole pairs which give rise to a current, which comprises the extracted signal. The resulting signal is, to a high degree of accuracy, proportional to the radiation energy density at any given wavelength.

Thermal excitation of the electron-hole pairs can also give rise to a dark current, which has been described in the literature and which is an undesired side effect of the RGB sensor, since it can increase the required artificial lighting at nighttime operation. In snow-sensing applications that operate in freezing and sub-freezing temperatures, the dark current is negligible. Another typically important parameter of a sensor diode is its time constant, but in the present applications the diode speed is not a limiting factor.

The color sensor can be configured to detect snow cover by the distinct surface color of snow—i.e., white. Therefore, it is important to understand the scattering of visible light off solids including snow and ice as compared to typical roof or pavement materials. The most important scattering mechanisms for visible ambient light are Rayleigh- and Mie-scattering. Both are entirely classical electromagnetic theories in that they conserve the wavelengths of the light. Rayleigh scattering refers to scattering centers with dimensions S small to the wavelength of the light, S<<λ, by an angle θ in a medium with an index of refraction n and can be expressed in closed form:

$$I = {I}_{0} \frac{1 + {cos}^{2} ( θ )}{2 {R}^{2}} {( \frac{2 π}{λ} )}^{4} {( \frac{{n}^{2} - 1}{{n}^{2} + 2} )}^{2} {( \frac{d}{2} )}^{6}$$

where R is the distance of the observer from the scattering particle. Rayleigh scattering is stronger on the blue end of the spectrum compared to the red end by an order of magnitude. Mie-scattering, or the more general Tyndall-scattering, describes scattering centers with comparable particle sizes to the wavelength of light, which is below 1 μm. Quantitatively, Mie scattering can only be solved numerically. In general, Mie scattering tends to exhibit “whiter” angle dependence compared to Rayleigh scattering and hence results in objects that appear to be white in the sun if their particles are weak absorbers, such as snow or clouds.

Quantum effects such as inelastic Raman scattering are not important to generate colors observed in the ambient environment. Rather, colored objects arise from the absorption of certain wavelengths, imparting the complementary color to the remaining light. Dark objects tend to absorb all wavelengths of light, but in terms of the spectral distribution of the light which is reflected, they tend to resemble white objects. Metals are a special case, since they tend to reflect most of the incident light regardless of wavelength on account of their high conductivity.

Significant differential color channels compared to snow were found whenever the surface consisted of a well-defined color in the RGB spectrum. Specifically chosen reference overlays, such as red or blue plates, give the most significant differential signal of 0.1 in the spectral content, whereas the red clay roofs common in most cold areas of the world also yield a consistent 0.05. Thus, red ceramic roofs and tiled surfaces, including clay brick surfaces and red roofing materials prevalent in many populated regions, are best suited for the purpose of distinguishing snow cover. Other surfaces, such as wood or tar roof shingles, asphalt, dark concrete, and metal surfaces, can still be monitored using the present systems but may benefit from use of a reference overlay placed at the measuring point as described above.

Example Color Sensor Housing

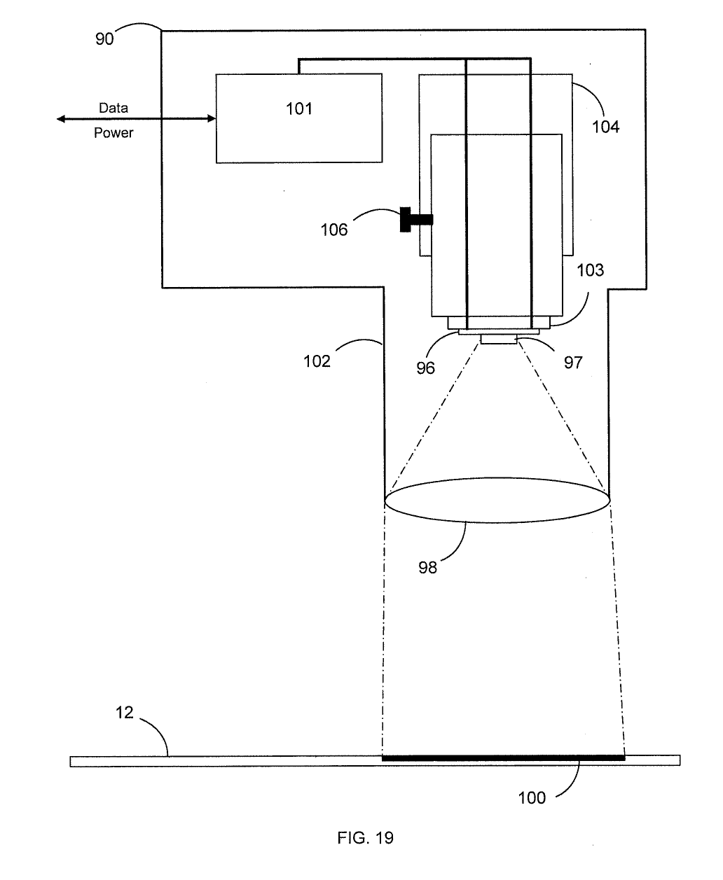

Considering the above description of a suitable RGB sensor as the color sensor 96, FIG. 19 illustrates an exemplary embodiment of a sensor housing 90 installed on a roof 12. The lens 98, which is convex, can be mounted at an end of a cylinder 102 projecting from the body of the sensor housing 90 toward the monitored surface (i.e., the roof 12). The cylinder 102 may accommodate the diameter and focal length of the lens 98; in particular, the diameter of the cylinder 102 at the distal end forms the aperture and retains the lens 98, and the cylinder 102 may be at least as long as the focal length of the lens 98. The cylinder 102 may further project a short distance beyond the lens 98 in order to block lateral stray light from hitting the lens 98, but not so far as to obscure the desired field of collection of the lens 98 (which corresponds to the monitored area of the roof 12 or other monitored surface). The sensor housing 90 can include a microcontroller 101 as described above. The color sensor 96 can be mounted on a substrate 103, such as a PCB with electrical connections. The substrate 103 can be attached to one end of an adjustable mount 104, which is mounted coaxially with the optical axis of the lens 98 to allow visual positioning of the color sensor 96 along the optical axis. The adjustable mount 104 can, in some embodiments, be a telescoping optical tube suitable for making minute adjustments in the position of the color sensor 96. The microcontroller 101 can be electrically connected to the color sensor 96 to provide power and data transmission lines.

In some embodiments, the location of an active area 97 of the color sensor 96 can be varied around the focal point of the lens 98. This adjustment can be performed by automating manipulation of the adjustable mount 104 during light collection, so that the length of the adjustable mount 104 can be changed by up to a few cm to always maximize the intensity of the light collected, independent of the height of the optics above the surface to be tested. In one embodiment, the adjustable mount 104 can include a motor 106 that can be electrically connected to the microcontroller 101, and the microcontroller 101 can be configured to optimize the collected light intensity by simultaneously detecting an intensity value transmitted by the color sensor 96 and operating the motor 106 to position the active area 97 at the location where the intensity is maximized. The motor 106 can alternatively or additionally be manually operated, or a manual adjustment mechanism, such as a knob or lever, can be provided to adjust the adjustable mount 104. Other embodiments provide for a static mount in place of the adjustable mount 104.

The classical equation for the location of an object o (here, the surface to be observed by the RGB sensor) and image i with respect to a lens with focal length f is:

$$\frac{1}{f} = \frac{1}{o} + \frac{1}{i} ⇒ i = \frac{of}{o - f} .$$

From this equation, the location of the image will be within 1 cm of the focal point if the observed surface is at least 50 cm from the lens. Since scattered light is to be gathered to determine the average color of a surface, finding the exact image location is not important. As long as the object (i.e., surface) distance is large compared to the focal length of the optics, any point near the focal point will be acceptable. In fact, the lateral placement of the sensing element is most sensitive to inaccuracies near the focal point, which is especially important for inexpensive lenses. Hence, in more static implementations than the automated adjusting described above, placing the sensing element slightly closer to the lens than the focal point can ensure the most robust light collection independent of the exact location of the sensor relative to the object surface.

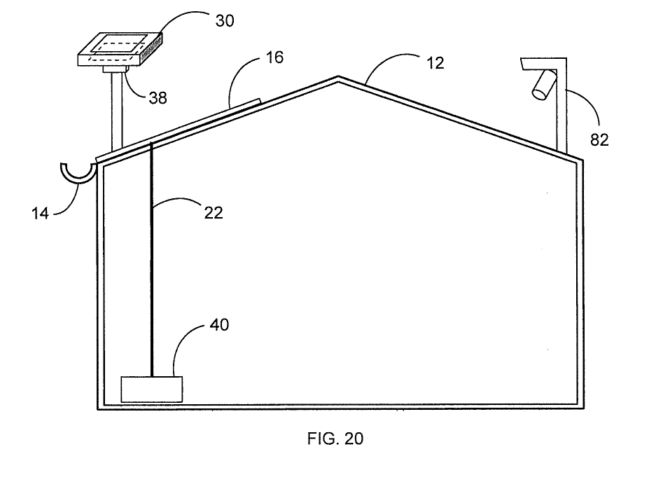

As described herein, a snow and ice melting heating system can include a probe, such as an aerial probe, having a capacitive sensor to improve detection of the onset or accumulation of snow or ice. The capacitive probe is a demonstrable improvement over existing precipitation sensors for snow and ice melting systems by providing uniform response to the presence of snow and ice while being protected from galvanic corrosion. A snow and ice melting system can additionally or alternatively include a light probe having a color sensor to improve detection of the accumulation and/or elimination of snow cover on a monitored surface. The light probe improves previous heating systems for such monitored surfaces by providing a monitoring device that can signal for the system heaters to be turned off when the snow cover has melted. Referring to FIG. 20, the snow and ice melting system can include one or more capacitive probes described herein, such as the aerial probe 30 of FIG. 7 or aerial probe 1100 of FIG. 11, and one or more light probes 82 as shown in FIG. 17. Each of the aerial probes 30 and each of the light probes 82 can have their own satellite controller, such as satellite controllers 38 and 84 described above, or one or more of the probes 30, 82 can utilize the same satellite probe or communicate directly with the primary controller 40. In one embodiment, the controller 40 can receive and process data from the aerial probe(s) 30 to determine that snow or ice is present or accumulating, and thus that it is appropriate to activate the heating cables 16; and, the controller 40 can receive and process data from the light probe(s) 82 to determine that snow or ice has melted, and thus that it is appropriate to deactivate the heating cables 16. In another embodiment, the controller 40 can analyze data from both the aerial probe(s) 30 and the light probe(s) 82 to determine an appropriate action to take. For example, a light probe 82 may report that the snow is melted, but the aerial probe 30 may report that snow continues to fall, so the controller 40 may determine to keep the heating cables 16 activated.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

What is claimed is:

1. A capacitive probe comprising:
a housing mountable to a building approximate an area to be monitored by the capacitive probe;
a capacitive sensor disposed partially within the housing and comprising:
a substrate;
a fringe capacitor comprising a pair of electrodes positioned on the substrate and at least partially arranged in a circular spiral that generates a fringe field having a range; and
a cap attached to the substrate and disposed over the fringe capacitor, the cap composed of a polytetrafluoroethylene (PTFE) material having a uniform dielectric constant throughout the cap, and the cap comprising a receiving surface disposed outside of the housing and at least partially disposed within the range of the fringe field; and
a sensor heater disposed in the housing, the sensor heater configured to heat the receiving surface a sufficient amount to melt snow on the receiving surface.

2. The capacitive probe of claim 1, further comprising a satellite controller disposed in the housing, the satellite controller comprising a microcontroller communicatively coupled to the sensor heater, and probing electronics communicatively coupled to the microcontroller and to the capacitive sensor, the microcontroller storing in memory:
program instructions; and
a detection threshold value based on a baseline capacitance of the fringe capacitor, the baseline capacitance measured:
when no moisture is present within the range of the fringe field; and
while the fringe capacitor is charged and discharged at an excitation frequency;
the microcontroller executing the program instructions to:
activate a capacitance reading operation in which the probing electronics charge and discharge the fringe capacitor at the excitation frequency;
determine a detected capacitance value obtained by the probing electronics during the capacitance reading operation;
determine that the detected capacitance value is greater than the detection threshold value; and
send a signal to a main controller in signal communication with the satellite controller, the signal instructing the main controller to activate a heater installed on the structure.

3. The capacitive probe of claim 2, wherein the excitation frequency is 10 kHz or less.

4. The capacitive probe of claim 2, wherein the detection threshold value is 50 pF or less.

5. The capacitive probe of claim 1, wherein the capacitive sensor is disposed at a top of the housing and the sensor heater is disposed at a bottom of the housing, the capacitive probe further comprising a fan disposed to uniformly distribute the heat generated by the sensor heater throughout the housing.

6. An apparatus for detecting the presence of snow or ice, the apparatus comprising:
a capacitive sensor comprising:
a substrate;
a fringe capacitor comprising a pair of electrodes positioned on the substrate, uniformly spaced apart, and arranged in a spiral; and
one or more coatings covering the fringe capacitor such that the fringe capacitor is protected from galvanic corrosion and responds to snow or ice present in a fringe field of the fringe capacitor.

7. The apparatus of claim 6, wherein the spiral is circular.

8. The apparatus of claim 6, wherein the one or more coatings have a predictable dielectric constant across a temperature range for detecting snow, and wherein an outer coating of the one or more coatings forms a receiving surface on which the snow accumulates, the receiving surface positioned at least partially within the fringe field of the fringe capacitor.

9. The apparatus of claim 6, further comprising a housing partially containing the capacitive sensor, the capacitive sensor being positioned in the housing such that falling snow or ice accumulates within the fringe field of the fringe capacitor.

10. The apparatus of claim 9, further comprising one or more heating elements disposed in the housing and positioned to heat the capacitive sensor to melt the snow or ice that accumulates within the fringe field of the fringe capacitor.

11. The apparatus of claim 6, further comprising:
probing electronics communicatively coupled to and reading data from the capacitive sensor; and
a controller communicatively coupled to the probing electronics and configured to receive the data from the probing electronics and determine that the data indicates the presence of water, snow, or ice.

12. The apparatus of claim 11, wherein the controller is in communication with a main controller of a snow and ice melting system and transmits a signal to the main controller to activate one or more heaters of the snow and ice melting system when the controller determines that the data from the sensor indicates the presence of snow or ice.

13. The apparatus of claim 11, wherein the probing electronics apply power to the capacitive sensor to charge and discharge the fringe capacitor at an excitation frequency greater than 10 kHz.

14. The apparatus of claim 11, further comprising:
a housing partially containing the capacitive sensor;
one or more heating elements disposed in the housing, communicatively coupled to the controller, and heating an interior of the housing;
an exterior temperature sensor disposed outside of the housing and communicatively coupled to the controller; and
an interior temperature sensor disposed inside of the housing and communicatively coupled to the controller;
the controller being further configured to:
determine that an exterior temperature detected by the exterior temperature sensor is 4 degC or less;
signal the probing electronics to read the data from the capacitive sensor;
determine that an interior temperature detected by the interior temperature sensor is 40 degC or less; and
signal the one or more heating elements to turn on.

15. An apparatus for detecting the presence or absence of snow on a monitored surface, the apparatus comprising:
a housing having an aperture;
a lens disposed in the aperture and positioned to receive light reflected from a monitored area of the monitored surface;
a color sensor disposed in the housing and positioned so that an active area of the color sensor is near the lens focal point; and
a first microcontroller electrically connected to the color sensor and configured to receive surface data from the color sensor, the surface data indicating the color of the light received by the lens.

16. The apparatus of claim 15 wherein the color sensor is an RGB sensor.

17. The apparatus of claim 15, further comprising one or more light sources arranged to illuminate the monitored area.

18. The apparatus of claim 15, further comprising a reference overlay placed over the monitored surface in the monitored area, the reference overlay having a uniform color detectably different from snow.

19. The apparatus of claim 15, further comprising a capacitive probe comprising:
a capacitive sensor comprising:
a fringe capacitor comprising a pair of electrodes positioned on a substrate, the pair of electrodes being uniformly spaced apart and arranged in a spiral; and
one or more coatings covering the fringe capacitor such that the fringe capacitor is protected from galvanic corrosion and responds to snow or ice present within a fringe field of the fringe capacitor; and
a second microcontroller electrically connected to the capacitive sensor and configured to receive a detected capacitance value of the fringe capacitor.

20. The apparatus of claim 19, wherein:
the first microcontroller and the second microcontroller are in signal communication with a main controller of a snow and ice melting system;
the first microcontroller sends a first signal to the main controller when the surface data indicates the absence of snow, the first signal instructing the main controller to deactivate one or more heaters of the snow and ice melting system; and
the second microcontroller sends a second signal to the main controller when the detected capacitance value indicates the presence of snow, the second signal instructing the main controller to activate the one or more heaters.
